(19) United States
(12) Patent Application Publication
(10) Pub. No.: US 2012/0197678 A1
(43) Pub. Date: Aug. 2, 2012

(54) Methods and Apparatus for Managing Interaction Processing

(76) Inventors: Herbert Ristock, Walnut Creek, CA (US); Nikolay Korolev, Concord, CA (US)

(21) Appl. No.: 13/018,880

(22) Filed: Feb. 1, 2011

(51) Int. Cl. G06Q 10/00

(52) U.S. Cl. 705/7.15

(57) ABSTRACT

A computing appliance includes a processor, an interface to an external network, an interface to a local area network, software executing on a machine-readable medium, wherein the software provides, a function for determining the ratio of busy time compared to idle time affecting a worker during task and multitask performance, a function for assigning a value defining a natural capacity of the worker to process a specific task type without developing a significant backlog, a function for assigning new tasks to the worker performing significantly under a natural capacity value for the type of task or tasks being processed, and a function for withholding one or more tasks from the worker performing near or at the natural capacity with developing backlog.

### BACKGROUND OF THE INVENTION

1. Field of the Invention

The present invention is in the field of digital telephony and pertains particularly to methods and apparatus for optimizing the time spent by a worker in a multitasking telephony environment.

2. Discussion of the State of the Art

Multitasking, or the performance of more than one task concurrently, is a common practice in state-of-art telephony contact centers. Task performance in multitasking in a contact center might include performance of tasks like answering email along with more immediate tasks like participating in a chat session. Generally speaking, contact center tasks can be further categorized or separated into two distinct groups. Firstly, tasks that can be performed without the worker experiencing a pattern of idle periods during the task performance phase and secondly, tasks where the worker experiences of idle periods interspersed with busy periods during the task performance phase.

A problem with efficiently processing the second task type mentioned above is that the worker cannot control the frequency or timing of and duration of idle periods experienced during the processing phase of the task resulting in an underutilized worker. Idle periods for a single task such as a chat session may approach fifty percent and above of the total session time. In an effort to correct the problem in a multitasking environment, it is known to assign a capacity skill to the worker that allows a routing system to know how many tasks of what type can be processed by a single worker in a multitasking environment. However, these capacity settings known to the inventor are static not dynamic and fail to account for the presence of idle period patterns encountered during the task performance phase in a multitasking environment. Another problem exists in routing in that for a pool of four workers, tasks of different types are generally distributed evenly [load balancing] amongst the workers leaving more workers handling fewer transactions.

Therefore, what is clearly needed are methods and apparatus for reducing idle time of workers during task performance in a multitasking telephony environment and for achieving more efficient distribution of tasks to workers.

### SUMMARY OF THE INVENTION

The problem stated above is that optimizing agent processing time when handling one or more interactions is desirable for a call center, but many of the conventional means for interactions, such as static work assignment conventions, do not account for agent multitasking with natural agent idle time periods interspersed throughout the interaction processing. The inventors therefore considered functional components of an interaction processing system, looking for elements that exhibit statistical reliability that could potentially be harnessed to provide workforce optimization but in a manner that would not create significant backlogs in interaction processing.

Every call center campaign is driven by the amount of successful customer interactions, one by-product of which is an abundance of satisfied consumers who have been optimally serviced. Most such call centers employ call center agents and interaction handling or processing stations to conduct the business of the center. Agent queues, interaction routers, and interaction processing stations and equipment are typically a part of such apparatus.

The present inventors realized in an intuitive moment that if, during interaction processing, the number of concurrent interactions processed by a single agent at one station could be managed according to the natural capacity of that agent for handling the type interactions, significant optimization in agent time utilization and reduction in agent idle time might result without producing backlog. The inventor therefore created at least one unique method supported by software resident on a digital medium that allowed an agent to process multiple interactions to increase agent production and reduce idle time. A significant improvement in workforce productivity results, with no impediment to quality of service or service level agreement goals created.

Accordingly, in one embodiment of the present invention, a computing appliance is provided comprising, a processor, an interface to an external network, an interface to a local area network, and software executing on a machine-readable medium, wherein the software provides a function for determining the ratio of busy time compared to idle time affecting a worker during task and multitask performance; a function for assigning a value defining a natural capacity of the worker to process a specific task type without developing a significant backlog; a function for assigning new tasks to the worker performing significantly under a natural capacity value for the type of task or tasks being processed; and a function for withholding one or more tasks from the worker performing near or at the natural capacity with developing backlog.

In one embodiment, the computing appliance functions as an interaction server. In one embodiment, the external network is the Internet network. In one embodiment, the worker is a call-center agent. In one embodiment, the tasks include one or more chat sessions, back office sessions, or voice sessions. In one embodiment, one of the task types is a priority and the other task types are deferred.

In one embodiment, the task is chat and the natural capacity value for processing one or more chat sessions depends upon the service type of the chat sessions. In one embodiment, post-work summary information, task proficiency information, and real-time performance information is statistically incorporated when establishing a natural capacity for a worker to process one or more tasks concurrently.

In one embodiment, the natural capacity value for a worker is specific to multitasking and may be calculated to reflect two or more different task types being processed by the worker concurrently. In one embodiment, the computing appliance further includes a task proficiency monitor for monitoring general proficiency of a worker in performance of certain tasks. In one embodiment a natural capacity value is specific to only one task type. In one embodiment, the natural capacity value self adjusts to account for unexpected conditions including unexpected delays in processing or idle time.

According to one aspect of the present invention, a method is provided for optimizing the time of a worker in a multitasking environment comprising the steps (a) establishing a natural capacity value defining the ability of the worker to work one or more specific task types concurrently without developing a significant backlog, (b) during a work period, routing or assigning a task to the worker and monitoring the load on the worker's natural capacity value established in step (a), (c) upon observance that the worker is performing significantly under the natural capacity value for that worker, routing or assigning a second task to the worker and monitoring the load on the worker's natural capacity value established in (a), (d) upon observance that the worker is performing at or near that worker's natural capacity value, withholding further tasks from the worker, and (e) upon observance that the worker is again performing significantly under the worker's natural capacity value established at step (a), and any processing backlog has been significantly reduced or eliminated, routing or assigning a new task to that worker.

In one aspect of the method, the worker is a call-center agent. In one aspect, in step (a), the natural capacity value is a measure created for a specific type of task wherein performance of the task involves periods of idle time for the worker. In one aspect of the method, in step (b), the load is the ratio of busy time to idle time for the worker while performing the task. In a preferred aspect, in step (c), the presence of significant idle time compared with busy time during task processing is indication of performing under the natural capacity value for that worker. In this same aspect, in step (d), the presence of significant busy time compared with idle time during task performance is indication of performing at or near the natural capacity value for that worker.

In one aspect of the method, in step (a), post-work summary information, task proficiency information, and real-time performance information is statistically incorporated when establishing a natural capacity for a worker to process one or more tasks concurrently. In one aspect, the method is practiced in a call center environment wherein the worker is a call center agent and the assigning or routing component is an interaction server.

### BRIEF DESCRIPTION OF THE DRAWING FIGURES

FIG. 1 is an architectural overview of a communications network supporting monitoring of natural capacity of telephony workers according to an embodiment of the present invention.

FIG. 2 is a block diagram illustrating periods of idle time and busy time the agent experienced during processing of a single interaction and the total amount of idle time and busy time involved.

FIG. 3 is a block diagram illustrating periods of idle time and busy time the agent experienced during processing of two interactions and the total amounts of idle time and busy time involved.

FIG. 4 is a process flow chart illustrating steps for reducing idle time of agents working interactions in a call center.

FIG. 5 is a block diagram illustrating a routing strategy for maximizing output for multitasking agents.

### DETAILED DESCRIPTION

The inventors provide methods and apparatus for measuring the natural capacity of a worker during processing of telephony interactions characterized by separated or alternating periods of busy vs. periods of idleness experienced by the worker. The system automatically gauges the overall amount of idle time and reduces that period during processing by giving the worker another interaction having the same busy/idleness characteristics for the worker. The present invention will be described in enabling detail using the following examples, which may describe more than one relevant embodiment falling within the scope of the present invention.

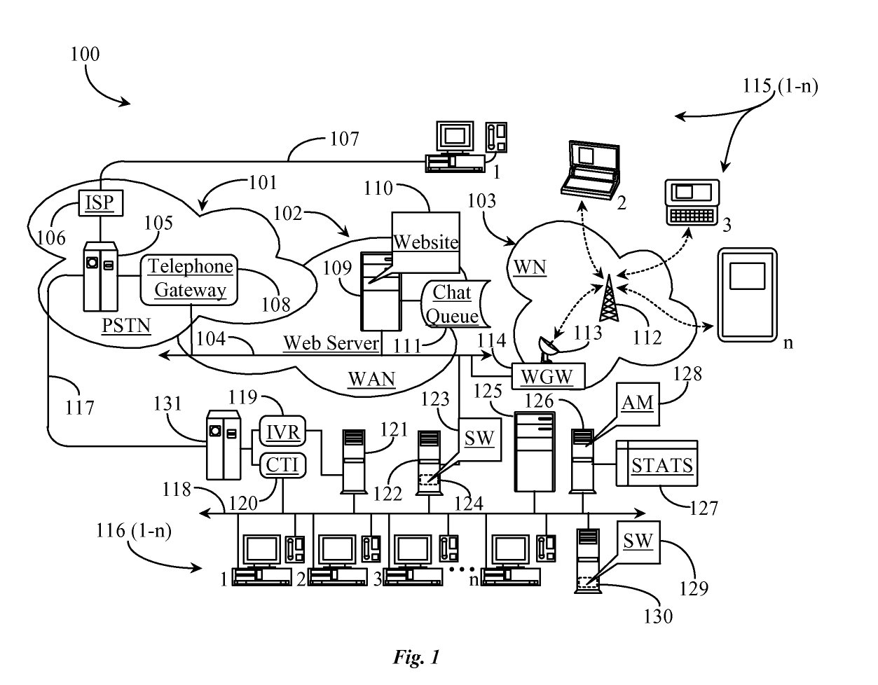

FIG. 1 is an architectural overview of a communications network 100 supporting monitoring of natural capacity of telephony workers according to an embodiment of the present invention. Communications network 100 includes a wide-area-network (WAN) 102, a public-switched telephony network (PSTN) 101, and a wireless carrier network (WN) 103. PSTN 101 may be any publicly switched telephone network. WAN 102 may be a corporate or public WAN including the Internet network. Wireless network 103 may be any wireless carrier network and is typically a cellular telephony network.

WAN 102 is the Internet network in a preferred embodiment because of its high public access characteristic and will be referred to herein as Internet 102. Internet 102 is further exemplified by a network backbone 104. Network backbone 104 represents all of the lines, equipment, and connection points that make up the Internet as a whole. Therefore, there are no geographic limitations to the practice of the present invention.

Network backbone 104 supports a web server 109. Web server 109 is adapted with a physical digital medium containing all of the data and software required to enable function as a web server. Web server 109 may be a third-party facility-offering web hosting services or it may be owned and maintained by a private enterprise and may be dedicated to service of only that enterprise. In this example, a website 110 is illustrated on server 109. Website 110 represents any website of an enterprise through which customers may communicate with enterprise representatives for the purpose of engaging in products and services.

Communication may be varied from the consumer perspective. For example, voice sessions might be conducted through website 110 as well as messaging, chat, and co-browsing sessions. In this example, a chat queue 111 is illustrated in association with server 109 and is mainly generic to website 110 through which consumers may engage in chat sessions with representatives of the enterprise.

A call center is illustrated in this example by a local area network (LAN) 118 supporting various equipment and facilities for practicing call-center interaction processing. LAN 118 supports a group of workers termed call center agents in the art of telephony. Each call center agent operates from an agent station 116 (1-n). Each agent station 116 (1-n) includes a LAN connected computing appliance and a switch-connected telephone for illustrative purposes only, as the exact equipment types may vary.

PSTN 101 includes a telephone switch 105. Switch 105 may be an automated call distributor (ACD) or a private branch exchange (PBX), or some other type of telephony switching facility without departing from the spirit and scope of the present invention. Telephone switch 105 is connected to a central office telephone switch 131 associated with the call center via a telephony trunk 117. Switch 131 represents the last hop for callers before being routed to agent stations 116 (1-n) via telephone. Switch 105 in PSTN 101 has connection to network backbone 104 and the Internet network through a telephone gateway 108. Gateway 108 is adapted by software executing from a physical medium to facilitate cross conversion of telephony traffic from the PSTN to the Internet network and from the Internet over the PSTN network.

Consumer appliances 115 (1-n) are illustrated in this example and are meant to include any computing appliances that may be used to access networks 102, 101, and 103. Computing appliance 115-1 is a desktop computer appliance with a telephone. A consumer operating equipment 115-1 connects to Internet 102 via an access line 107, and an Internet service provider (ISP) 106. The methods of connection may vary upon the equipment used and the available technical avenues for accessing the Internet. Cable modem, telephone modem, satellite, digital services line (DSL), broadband, and WiFi are just some of the available connection methods to consider that may be used to gain access to Internet 102, more particularly to website 110.

Consumer appliances 115-2, 3, and n are wirelessly enabled to connect to network backbone 104 via a cell tower 112, a transceiver 113, and a wireless multimedia gateway (WGW) 114 for bridging the communications between wireless network 103 and Internet 102. Consumer appliance 115-2 is a Laptop computer and 115-3 is a cellular telephone.

Computing appliance n is an iPad type device. It may be assumed in this example, that each of the consumers operating appliances 115 (1-n) are connected to website 110 and have requested to chat with an agent. Chat queue 111 at server 109 queues the requests to the call center.

LAN 118 supports a routing server 122 connected to Internet backbone 104 by way of an Internet access line. Routing server 122 includes a physical digital medium 124 that contains all of the data and software required to enable interaction routing. All requests from website 110 are sent to routing server 122 for distribution to agents operating at agent stations 116 (1-n). Telephone switch 131 is enhanced for intelligent routing of voice interactions via a computer telephony integration (CTI) processor 120. CTI processor 120 is connected to switch 131 via a CTI link. CTI processor 120 provides intelligent control over switch 131. Telephone switch 131 also has an interactive voice response (IVR) capability via an IVR 119.

LAN 118 supports an application server 121 for serving voice application to callers waiting in queue. CTI processor 120 is connected to LAN 118 enabling service to the switch and other maintenance through CTI functionality. LAN 118 supports a messaging server 125 adapted with a physical digital medium containing all of the required software and data to enable function as a message server or router. LAN 118 supports a statistics server 126. Stat server 126 includes a physical digital medium containing all of the software and data required to enable function as a statistics server. Stat server 126 has connection to a repository 127 adapted to contain call center statistics along with performance statistics about agents working at the center.

Routing server 122 routes all interaction requests such as requests for chat to appropriate agents along with any other duties that arise during the day. In one embodiment messaging server 125 may route messages addressed to specific agents to their inboxes or to a shared agent queue. In one embodiment routing server 122 also routs electronic messages addressed to agents. Stat server 126 provides all of the performance statistics for the center as a whole and for each of the agents working at stations 116 (1-n). LAN 118 also supports a workforce-scheduling server 132. Workforce scheduling server 132 includes a physical digital medium 130 that contains all of the software and data required to function as a workforce-scheduling server.

In this example, the nature of interactions to be processed by agents is characterized by periods of idle time and busy time for the agents processing those interactions. A good example of this type of interaction is a chat session. A chat session includes periods of time when the consumer is typing and the agent is idle waiting for the typed response. The agent is busy only when the agent is typing a response to the consumer during the session. An example of an interaction that does not include any forced idle time for the agent is answering an email. Processing email messages can be done as an un-interrupted activity. Another example of a task with a forced idle period is back office work performed by multiple actors. In this case the processing is moving between two or more actors back and forth and each actor has a forced idle time while waiting for the next processing focus phase.

To effectively utilize an agent's time processing types of interactions that are characterized by these forced periods of idle time, a software component 123 is provided to be executable from the physical digital medium 124 of routing server 122. Software component 123 includes a function for determining the ratio of busy time compared to idle time affecting a worker during task and multitask performance, a function for assigning a value to an agent, the value defining a natural capacity of an agent to process a specific task type without developing a significant backlog, a function for assigning new tasks to the agent performing significantly under a natural capacity value for the type of task or tasks being processed, and a function for withholding one or more tasks from the worker performing near or at the natural capacity with developing backlog.

An agent monitoring application 128 is provided to reside on the physical digital medium of statistics server 126. Application 128 monitors each agent during interaction processing to determine the current performance rating of each agent and to evaluate the effects of any other situations which may affect the normal capacity of the agent to perform at a certain performance level or value. Application 128 is not specifically required in order to practice the present invention. SW 123 has the capability of monitoring each agent's idle periods and is capable of quantifying the approximate amount of idle time an agent incurs over a typical single chat session.

When an agent such as one operating station 116-1 receives a chat request and accepts the chat from chat queue 111, in this example, SW 123 begins to measure the agent's idle time to busy time ratio during the chat session. In a typical chat session, an agent may spend up to fifty percent of the interaction time idle, or waiting for the consumer to type a chat response to the last block by the agent. It is desired that idle time be reduced, but without creating any delay in processing such that a backlog might develop. A natural capacity value is assigned to the agent that defines how many chat sessions the agent can process without developing a backlog.

If agent 116-1 is processing only a single chat, he is most likely working significantly under his or her natural capacity for handling a chat session. This will be evidenced by a significantly higher level of idle time experienced by the agent during the session. The routing server aided by SW 123 may route a second chat session to the agent in an effort to reduce the amount of idle time the agent is currently experiencing. Routing server 122 knows how much idle time the agent is currently experiencing. The server knows the “natural capacity” of the agent relative to multitasking to process more than one chat session concurrently. Natural capacity of an agent specific to chat interactions may be defined as the number of chat sessions that can be processed by a given agent without slowing down (statistically) the processing of each individual chat. Therefore, natural capacity values may be assigned to all of the agents for specific interaction types or for specific mixes of different interaction types in a multitask setting.

In one embodiment a natural capacity value for an agent applies only to one type of interaction where it accounts for forced idle time periods. That is to say that the agent may have a natural capacity value for chat and a different natural capacity value for performing backup office work with other workers. In one embodiment, the natural capacity values for two different interaction types for an agent may be aggregated and averaged or merged mathematically if the agent is working both interaction types concurrently.

In one embodiment all or part of SW 123 may be resident on a physical digital medium other than medium 124 in server 122. For example, a version of or a portion of SW 123 is shown installed as SW 129 on a physical digital medium 130 associated with a workforce-scheduling server 132. In this aspect, the SW (129) may function to maintain and periodically update the natural capacity values for the agent's in all of the applicable interaction types. These values can be used in scheduling formulas for certain interaction campaigns of incoming interactions or outbound proactive contact campaigns such as proactive chat campaigns for example. Pre-knowledge of the natural capacity values for the agents aids in calculating exactly how many agents will be required to handle an estimated interaction processing load.

In one embodiment of the present invention, the amounts of idle time for any interaction type of an averaged session period can be accurately predicted based on historical data and active monitoring. In a one on one chat, idle time experienced by an agent may be more accurately predicted in real time by knowing the proficiency of the consumer the agent is interacting with. Therefore, in one embodiment of the invention, the proficiency of the consumer in typing a chat response might be taken into account when predicting the actual idle time an agent will experience during the session. With real time monitoring, an accurate prediction may be made during the beginning of the session such that the natural capacity value of the agent is slightly adjusted up or down depending on the current proficiency variable of the consumer. This process may be extended to multi-party chat as well.

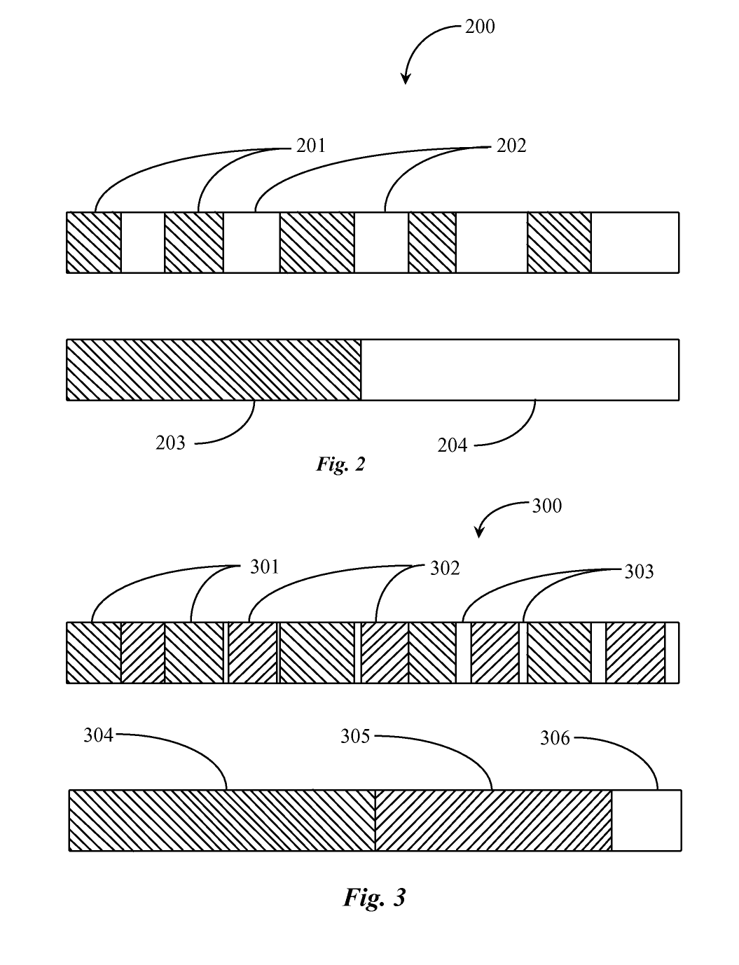

FIG. 2 is a block diagram 200 illustrating periods of busy time and idle time the agent experienced during processing of a single interaction and the total amount of busy time and idle time involved during the interaction. Diagram 200 is represented herein by two bars, a first bar illustrated directly above a second bar. In the first bar, the SW of the present invention has identified the busy time periods 201 that an agent experiences during a typical length or duration of a single interactive session where duration is represented by the physical length of the bar (not scaled). Similarly, the idle periods 202 of the agent during the interactive session period are also identified. The active and idle periods may be calculated in real time through agent monitoring with an application such as agent monitor application 128 of FIG. 1 running on statistics server 126.

Referring now to the second bar representing the same interactive session, the total busy time 203 is calculated by summing busy periods 201 over the length of the session. Similarly, the total idle time 204 for the agent over the length of the interactive session is calculated. In this example, the agent is busy only 40% or so of the total length of the chat session. The agent is idle for more than 50% of the duration of the current session. The significant amount of idle time compared with busy time is indication that the agent is performing under the natural capacity for that agent to efficiently handle that interaction type. The natural capacity is the measure of how many interactions can be process concurrently without delaying the interaction handling or creating a backlog. It is clear in this example that routing a second interaction to the same agent for concurrent processing will reduce the idle time of the agent significantly and hopefully without sacrificing the quality of service (QoS) provided by the agent.

FIG. 3 is a block diagram 300 illustrating periods of busy time and idle time the agent experienced during processing of two interactions and the total amounts of busy time and idle time involved. Diagram 300 is represented herein by two bars, a first bar illustrated directly above a second bar. In this embodiment, the agent is provided with two interactions to be process concurrently in order to reduce the idle time experienced by the agent during interaction processing.

In the first bar, the SW of the present invention has identified the busy time periods 301 that an agent experiences during a typical length or duration of a first interactive session where duration is represented by the physical length of the bar (not scaled). The SW also documents the busy time periods 302 that the agent experiences during a typical length or duration of a second interactive session, also represented by the length of the bar and where the sessions are being concurrently processed by the agent. The amount of time the agent is not busy processing one or the other of the interactions is represented herein by idle time periods 303. Periods 303 represent the time slots where the agent is idle or not actively processing either of the interactions. Referring now to the second bar now representing two interactive sessions, the total busy time 304 is calculated for the first session and the total busy time 305 is calculated for the second session. Given the same approximate session duration applicable to both sessions, the remaining unaccounted for time is the idle time total 306 when the agent is not actively processing either interactive session or the sum of idle periods 303. Note that idle time 306 for the same length of session time has been significantly reduced to about 10% of the total session time. A formula for expressing a natural capacity value for an agent for an interaction type is provided to obtain an approximate value indicating the number of interactions of type that the agent can process concurrently without delaying processing, creating backlog, or sacrificing QoS.

If N is the natural capacity for the interaction type chat for agent A and A is having only a single chat with one person B, then A will likely receive at least one additional chat session to process in a multitasking environment in order to reduce the idle time for that agent. As long as person B does not experience any slow-down in the chat progression with agent A, the occupancy of A in the processing of one or more additional sessions concurrently with the first session didn't exceed the natural capacity for that agent to handle the interactions without developing backlog, lengthening processing time or delaying any responses to the chat participants.

In one embodiment, natural capacity can be defined as the maximum number of concurrent chats for a person that can be processed in steady state mode meaning that over the longer duration of time there is no accumulation of backlog.

An approximation for natural capacity is given by the following formula:

$$N = ⌈ \frac{S}{A} ⌉ ,$$

where S is equal to average single chat session duration and A is equal to the average time an agent spends processing a single chat. [X] may be rounded up to the next whole integer greater than the actual value of [X]. In actual practice, the formula might be rewritten as follows:

$$N = ⌈ \frac{1}{P} ⌉ ,$$

where P is equal to the portion of a typical single chat session that the agent is busy.
In the case illustrated in FIG. 2 above, P is equal to 40% or 0.4. Therefore,

$$N = ⌈ \frac{1}{0.4} ⌉ = ⌈ 2.5 ⌉ = 3.$$

In one embodiment of the present invention, the formula described above might be used as the underlying model of a contact center, for example, in workforce planning and scheduling, and routing and reporting. Other variables might be considered in more complex models without departing from the spirit and scope of the present invention. For example, interaction type mixing might be considered where the natural capacity value for an agent self adjusts to account for the different interaction types being processed concurrently.

In one embodiment a predictive element is added giving the center the ability to predict what the actual idle time for an agent will look like for a pending interaction. Real-time monitoring during interactions can be practiced for the purpose of maintaining the optimum busy and idle factors for agents through routing regimens based on the formula. Furthermore, other network factors might affect processing slightly such as network latency, overall interaction loads, differences in consumer proficiency, and other potential variables.

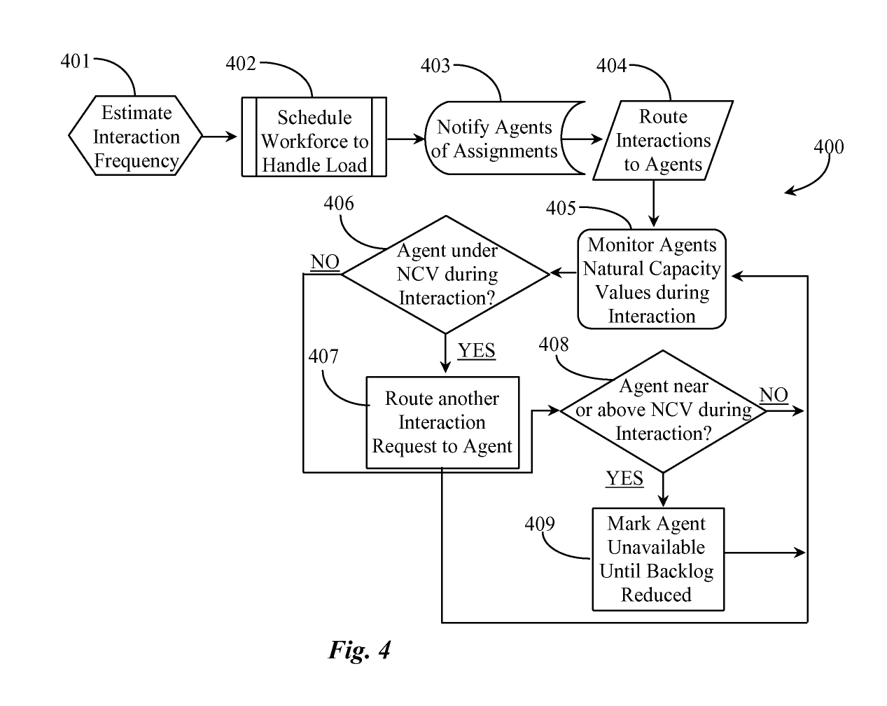

FIG. 4 is a process flow chart 400 illustrating steps for reducing idle time of agents working interactions in a call center. At step 401, the call center estimates the interaction frequency for an upcoming interaction campaign. This can be performed relatively accurately if historical records exist for similar campaigns. The campaign that is target of the planning might be an incoming campaign or a planned outbound campaign. Once the interaction load is predicted the workforce is scheduled to handle the projected workload. The load may be characterized by interactions in which agents experience idle periods staggered throughout the session like during chat sessions, co-browsing sessions, and collaborative work sessions. In one embodiment, work that may be accomplished without interruption may be reserved for agents to process when higher priority interactions are scarce.

Once the workforce scheduler has identified the agents that will be tapped for the campaign, the scheduler notifies the selected agents of their assignments during the campaign. At step 404 the center begins routing interactions to the agents. It is assumed in this process that the agents all have natural capacity values assigned to them for the type interaction that they will be processing. It is also assumed in this process that the natural capacity values are used to help determine the minimum number of agents that are required to eliminate the problem or threat.

At step 405, an agent monitoring application such as AM 128 of FIG. 1 monitors the agents' natural capacity values during their interactions. This is done for the purpose of maintaining a healthy load of interactions without creating any backlogs. At step 406 the processing host determines if there are any agents working interactions under the natural capacity for that agent in working the type interaction. If an agent is determined at step 406 to be working significantly below the natural capacity value for that agent to handle the type interaction, the process may skip to step 408 where it is determined if any agent is working at or above the natural capacity value for those agents for those type interactions. If at step 408, there are no agents working at or above their natural capacity values, the process may resolve back to step 405 and continue monitoring agents.

If at step 406, it is determined that there is an agent working significantly below the natural capacity value for that agent for the type interaction, a second interaction request of the type is routed to the agent and the agent processes the interactions concurrently. The process moves back to step 405 for further monitoring. If at step 408, it is determined that there is an agent performing at or above the natural capacity value for that agent for the type interaction, then the routing system may mark the agent unavailable and will withhold further interactions to that agent until the backlog for that agent is cleared and the agent is performing significantly below the natural capacity value for that agent for the type interaction. The process continually resolves back to monitoring after any determination and subsequent action.

In one embodiment, there is a process line for making adjustments to an agent's natural capacity value during real time interaction based on one or more events or phenomena. Monitoring may take into account some of these events or phenomena and act in such a way as to cause an agent's natural capacity value to be fine-tuned up or down in response to the event or phenomena. The amount of idle time (sum of periods) an agent experiences during the length of a single interaction or during concurrent interaction processing is indicative of whether that agent is working below or at or above the natural capacity for that agent to process the type interaction. A predictive element might be introduced where based on historical performance. The amount of idle time for a pending interaction can be accurately predicted. In this predictive embodiment, the routing assignments can be stacked in queue for an agent ahead of the agent engagements.

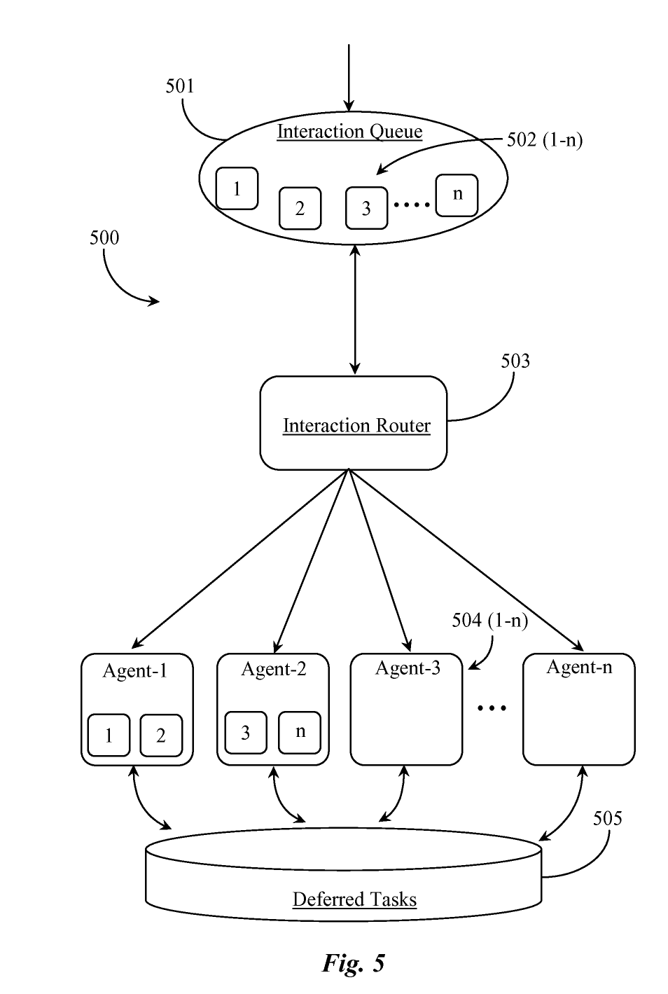

FIG. 5 is a block diagram 500 illustrating a routing strategy for maximizing output for multitasking agents. Diagram 500 includes an interaction queue 501. Queue 501 is a shared queue in this example. Agents 504 (1-n) share Queue 501 in this embodiment. Agents 504 (1-n) are charged with answering interaction requests 501 (1-n) waiting or pending in queue 501. An interaction router 503 is provided to route the interaction requests waiting in queue 501 to available agents. The type of campaign may be a proactive outbound campaign wherein interaction requests 502 (1-n) are processed as incoming requests. The campaign type might just be normal incoming traffic.

In this embodiment, agents are also charged with working on deferred tasks like email. Deferred tasks are illustrated as residing on a physical medium 505 available to the agents. That is to say that agents who do not have interaction work may stay busy be working on deferred tasks. Agents 504 (1-n) are adapted in this example to handle chat interaction requests and interaction requests 502 (1-n) are assumed to be chat requests in this example. It so happens in routing requests, it is important that each agent be working closer to his or her natural capacity value for handling chat interactions.

With four chat requests in queue 501, the interaction router determines that agents 504-1 and 504-2 would be working under capacity if they only processed a single chat because of the forced idle time they would experience. Therefore, given that the processing of chat holds priority over processing deferred tasks, and that each agent may process two chat interactions to be near capacity for each agent, the four chats are immediately routed to the first two agents 504 (1,2). Agents 504 (3-n) are immediately assigned to work deferred tasks until there are more chat requests in queue 501 to route to additional agents.

In standard routing without considering multitasking with forced idle periods, each agent would be distributed one chat interaction, and would have to mitigate idle time by manually processing emails or other deferred tasks while chatting. Empirical data shows that the agents are best utilized when processing two chats concurrently rather than processing one chat and deferred tasks concurrently. As more chat requests arrive in queue, additional agents are assigned to chat at near his or her natural capacity value for handling chat. This ensures that each agent processing the priority interactions is optimally utilized and not experiencing significant idle time. If one or more agents begin processing at or above natural capacity values then interaction router 503 may withhold routing to the “busy” agents until they clean up their developing backlogs and are ready by natural capacity value assessment to take another interaction request.

All newly arrived chat sessions are routed to agents in a way that minimizes the current number of agents processing chats. It is also assumed that all agents not processing chats are processing deferred tasks. The routing strategy transfers a chat to an agent with the highest number of chats currently being served while still remaining within the natural capacity value of that agent for processing chats. Some agents will only be able to process two chats but others may have a higher natural capacity and may process three or even four chats simultaneously without sacrificing QoS. When chat requests in queue 501 begin to decrease, the agents that are processing fewer chats may be transferred to deferred task processing. The number of served deferred tasks will be increased.

Assume that there are only three agents in a group and two chat requests in queue. Traditionally, two agents would receive chat requests and the third agent would be assigned to deferred tasks. In an embodiment of the invention, the optimized routing would cause one agent to be assigned both chats while the remaining two agents would serve deferred tasks. The more efficient strategy enables four items to be pursued concurrently instead of only three items.

The method of routing based on natural capacity to handle more than one of an interaction type may be applied to a mix of interaction types such as voice+chat for example. In one embodiment, the interactions are further divided in routing by agent skill set required to process them. In this case the highest priority interactions are routed to the agent with the highest natural capacity value and the highest skill level for processing that type of interaction. More interaction type can be incorporated in one campaign such as voice+chat+email, for example. Further enhancements may involve detailed agent capacity modeling for different interaction types and mixes without departing from the spirit and scope of the present invention.

It will be apparent to one with skill in the art that the methods and apparatus of the invention may be provided using some or all of the mentioned features and components without departing from the spirit and scope of the present invention. It will also be apparent to the skilled artisan that the embodiments described above are specific examples of a single broader invention, which may have greater scope than any of the singular descriptions taught. There may be many alterations made in the descriptions without departing from the spirit and scope of the present invention.

What is claimed is:

1. A computing appliance comprising:
a processor;
an interface to an external network;
an interface to a local area network; and
software executing from a machine-readable medium;
wherein the software provides:
a function for determining the ratio of busy time compared to idle time affecting a worker during task and multitask performance;
a function for assigning a value defining a natural capacity of the worker to process a specific task type without developing a significant backlog;
a function for assigning new tasks to the worker performing significantly under a natural capacity value for the type of task or tasks being processed; and
a function for withholding one or more tasks from the worker performing near or at the natural capacity with developing backlog.

2. The computing appliance of claim 1, functioning as an interaction server.

3. The computing appliance of claim 1, wherein the external network is the Internet network.

4. The computing appliance of claim 1, wherein the worker is a call-center agent.

5. The computing appliance of claim 1, wherein the tasks include one or more chat sessions, back office sessions, or voice sessions.

6. The computing appliance of claim 1, wherein one of the task types is a priority and the other task types are deferred.

7. The computing appliance of claim 1, wherein the task is chat and the natural capacity value for processing one or more chat sessions depends upon the service type of the chat sessions.

8. The computing appliance of claim 1, wherein post-work summary information, task proficiency information, and real-time performance information is statistically incorporated when establishing a natural capacity for a worker to process one or more tasks concurrently.

9. The computing appliance of claim 1, wherein the natural capacity value for a worker is specific to multitasking and may be calculated to reflect two or more different task types being processed by the worker concurrently.

10. The computing appliance of claim 1, further including a task proficiency monitor for monitoring general proficiency of a worker in performance of certain tasks.

11. The computing appliance of claim 1, wherein a natural capacity value is specific to only one task type.

12. The computing appliance of claim 1, wherein the natural capacity value self adjusts to account for unexpected conditions including unexpected delays in processing or idle time.

13. A method for optimizing the time of a worker in a multitasking environment comprising the steps:
(a) establishing by execution of software on a computing appliance a natural capacity value defining the ability of the worker to work one or more specific task types concurrently without developing a significant backlog;
(b) during a work period, routing or assigning a task to the worker and monitoring the load on the worker's natural capacity value established in step (a);
(c) upon observance that the worker is performing significantly under the natural capacity value for that worker, routing or assigning a second task to the worker and monitoring the load on the worker's natural capacity value established in (a);
(d) upon observance that the worker is performing at or near that worker's natural capacity value, withholding further tasks from the worker; and
(e) upon observance that the worker is again performing significantly under the worker's natural capacity value established at step (a), and any processing backlog has been significantly reduced or eliminated, routing or assigning a new task to that worker.

14. The method of claim 13 wherein the worker is a call-center agent.

15. The method of claim 13 wherein in step (a), the natural capacity value is a measure created for a specific type of task wherein performance of the task involves periods of idle time for the worker.

16. The method of claim 13 wherein in step (b), the load is the ratio of busy time to idle time for the worker while performing the task.

17. The method of claim 13 wherein in step (c), the presence of significant idle time compared with busy time during task processing is indication of performing under the natural capacity value for that worker.

18. The method of claim 13 wherein in step (d), the presence of significant busy time compared with idle time during task performance is indication of performing at or near the natural capacity value for that worker.

19. The method of claim 13 wherein in step (a), post-work summary information, task proficiency information, and real-time performance information is statistically incorporated when establishing a natural capacity for a worker to process one or more tasks concurrently.

20. The method of claim 13 practiced in a call center environment wherein the worker is a call center agent and the assigning or routing component is an interaction server.
